(19) United States
(12) Patent Application Publication
(10) Pub. No.: US 2026/0171284 A1
(43) Pub. Date: Jun. 18, 2026

(54) FLAT WIRING LAMINATED MEMBER AND WIRE HARNESS

(71) Applicant: Yazaki Corporation, Tokyo (JP)

(72) Inventors: Shodai Suzuki, Shizuoka (JP); Yuki Tosaya, Shizuoka (JP); Takashi Uembyu, Shizuoka (JP); Makoto Kambe, Shizuoka (JP)

(21) Appl. No.: 19/404,776

(22) Filed: Dec. 1, 2025

(30) Foreign Application Priority Data
Dec. 16, 2024 (JP) 2024-219669

(51) Int. Cl. H01B 7/00; H01B 7/02; H01B 13/10

(52) U.S. Cl. CPC H01B 7/0045; H01B 7/0258; H01B 13/10

(57) ABSTRACT

A flat wiring laminated member includes a plurality of electric wires each having a linear outer shape, and a sheet member that is a sheet-like insulator collectively covering the plurality of electric wires and is allowed to be folded and laminated in a state of covering the electric wires. The sheet member includes a linear tearing portion that is formed in a manner of connecting one end portion and another end portion in the axial direction between the electric wires adjacent to each other in the sheet member, and serves as a fold when the sheet member is folded, the linear tearing portion being allowed to be torn along the linear portion with a tearing force of less than 4.91 N, and a fixing portion that is provided on overlapping surfaces of the sheet member in a folded state and configured to fix the overlapping surfaces in the folded state.

### CROSS-REFERENCE TO RELATED APPLICATIONS

This application is based on and claims priority under 35 USC 119 from Japanese Patent Application No. 2024-219669 filed on Dec. 16, 2024, the contents of which are incorporated herein by reference.

### TECHNICAL FIELD

The present disclosure relates to a flat wiring laminated member and a wire harness.

### BACKGROUND ART

A wire harness used in an automobile is desired to be reduced in height in order to maximize a space in a vehicle cabin of the vehicle. In the related art, a part of the wire harness is formed of a flat member such as the flat cable (FC), the flexible flat cable (FFC), and the flexible printed circuit (FPC), thereby meeting the demand for height reduction. However, these structures have many demerits such as difficulty in wire harness branching and terminal processing and are not suitable for large circuits. Therefore, a structure suitable for wiring of a large circuit may be obtained by laminating flat members. Meanwhile, in a structure in which flat members are laminated, since it is necessary to maintain a state in which the respective layers are laminated, a time required for adhesion and fixation of the respective layers and a material for adhesion and fixation are required. In addition, when producing the respective layers, time and equipment are required to manufacture the wiring material. Further, it is necessary to accurately position the respective layers to be laminated. With respect to this, there is known a technique in which a fold is provided in a length direction of one FFC and the FFC is folded along the fold to form a laminated structure (Patent Literature 1). Meanwhile, in order to branch a distal end in the FFC according to Patent Literature 1, it is necessary to provide a cut portion previously at a portion to be branched. With respect to this, there is also known a structure in which a perforation is provided in an FFC, allowing the FFC to be separated at the position of the perforation by tearing the perforation (Patent Literature 2).

### CITATION LIST

### Patent Literature

Patent Literature 1: JP2004-22426A
Patent Literature 2: JP2010-244714A

### SUMMARY OF INVENTION

However, in the FFC according to Patent Literature 2, a cut portion called a half cut is formed along the perforation. Therefore, in order to branch the distal end, it is necessary to previously provide a cut portion in the FFC, requiring additional labor for providing the cut portion.

The present disclosure has been made to solve such a problem, and an object of the present disclosure is to provide a flat wiring laminated member and a wire harness in which a distal end can be branched without previously providing a cut portion even in a structure in which a flat member can be folded and laminated.

A flat wiring laminated member of the present disclosure includes a plurality of electric wires each having a linear outer shape and arranged in a width direction orthogonal to an axial direction of the electric wire, and a sheet member that is a sheet-like insulator collectively covering the plurality of electric wires and is allowed to be folded and laminated in a state of covering the electric wires. The sheet member includes a linear tearing portion that is formed in a manner of connecting one end portion and another end portion in the axial direction between the electric wires adjacent to each other in the sheet member, and serves as a fold when the sheet member is folded, the linear tearing portion being constructed to be allowed to be torn along the linear portion with a tearing force of less than 4.91 N, and a fixing portion that is provided on overlapping surfaces of the sheet member in a folded state and configured to fix the overlapping surfaces in the folded state.

A wire harness of the present disclosure is obtained by folding and laminating the sheet member of the flat wiring laminated member described above.

According to the present disclosure, it is possible to provide a flat wiring laminated member and a wire harness in which a distal end can be branched without previously providing a cut portion even in a structure in which a flat member can be folded and laminated.

### BRIEF DESCRIPTION OF DRAWINGS

FIG. 1 is a plan view illustrating a flat wiring laminated member according to an embodiment of the present disclosure;

FIG. 2 is a cross-sectional view taken along a line A-A in FIG. 1;

FIG. 3 is a cross-sectional view illustrating a modification of an electric wire of the flat wiring laminated member illustrated in FIG. 2;

FIG. 4 is a front view illustrating a state in which the flat wiring laminated member illustrated in FIG. 1 is folded;

FIG. 5 is a cross-sectional view illustrating a modification of a tearing portion of the flat wiring laminated member illustrated in FIG. 2;

FIG. 6 is a plan view illustrating a first modification of a concave portion and a convex portion included in the flat wiring laminated member, and corresponds to FIG. 1;

FIGS. 7A and 7B are diagrams illustrating a second modification of the concave portion and the convex portion included in the flat wiring laminated member, in which FIG. 7A is a plan view illustrating a state in which the flat wiring laminated member is folded and laminated, and FIG. 7B is a partially enlarged front view of FIG. 7A,

FIGS. 8A and 8B are diagrams illustrating a third modification of the concave portion and the convex portion included in the flat wiring laminated member, in which FIG. 8A is a plan view illustrating a state in which the flat wiring laminated member is folded and laminated, and FIG. 8B is a partially enlarged front view of FIG. 8A;

FIGS. 9A and 9B are diagrams illustrating a fourth modification of the concave portion and the convex portion included in the flat wiring laminated member, in which FIG. 9A is a plan view illustrating a state in which the flat wiring laminated member is folded and laminated, and FIG. 9B is a partially enlarged front view of FIG. 9A;

FIG. 10 is a cross-sectional view illustrating a fifth modification of the concave portion and the convex portion included in the flat wiring laminated member, and corresponds to FIG. 2;

FIGS. 11A to 11C are plan views illustrating a sixth modification of the concave portion and the convex portion included in the flat wiring laminated member, in which FIG. 11A illustrates a case in which a planar shape of the concave portion and the convex portion is circular, FIG. 11B illustrates a case in which the planar shape of the concave portion and the convex portion is square, and FIG. 11C illustrates a case in which the planar shape of the concave portion and the convex portion is rhombic;

FIGS. 12A to 12C are diagrams illustrating a procedure for manufacturing a wire harness, in which FIG. 12A illustrates the flat wiring laminated member (a fixing portion is omitted) used for manufacturing, FIG. 12B illustrates a state in which a part of tearing portions illustrated in FIG. 12A is torn, and FIG. 12C illustrates a state in which a sheet member illustrated in FIG. 12B is folded;

FIG. 13 is a plan view illustrating a modification of folding the sheet member illustrated in FIG. 12; and

FIGS. 14A and 14B are perspective views illustrating a flat cable used in a test for confirming whether folding and tearing are possible, in which FIG. 14A illustrates a state before a tearing test is performed, and FIG. 14B illustrates a state during the tearing test, and electric wires are not illustrated.

### DESCRIPTION OF EMBODIMENTS

Hereinafter, the present disclosure will be described with reference to a preferred embodiment. The present disclosure is not limited to the embodiment to be described below, and the embodiment can be appropriately changed without departing from the gist of the present disclosure. In the embodiment to be described below, there may be parts in which illustration and description of a part of a configuration are omitted, and it is needless to say that a public or well-known technique is appropriately applied to details of an omitted technique within a range in which no contradiction with contents to be described below would occur.

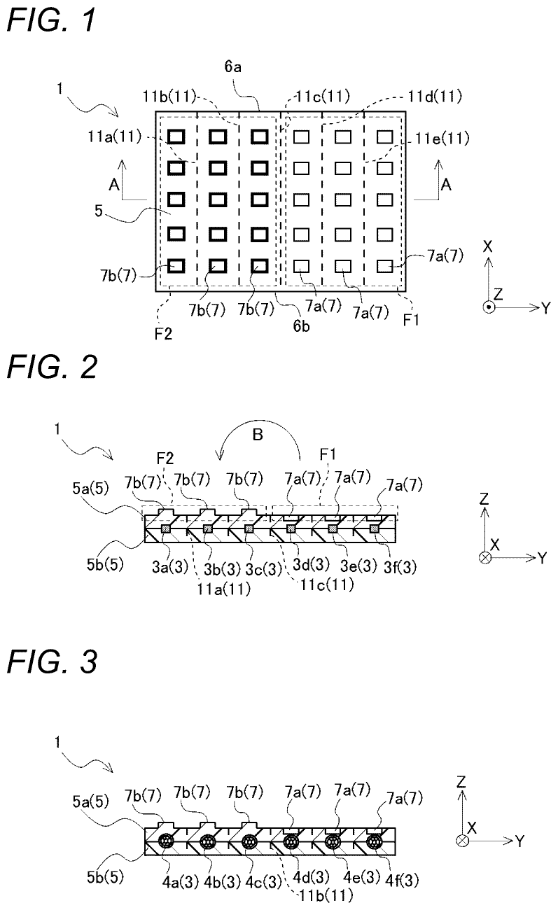

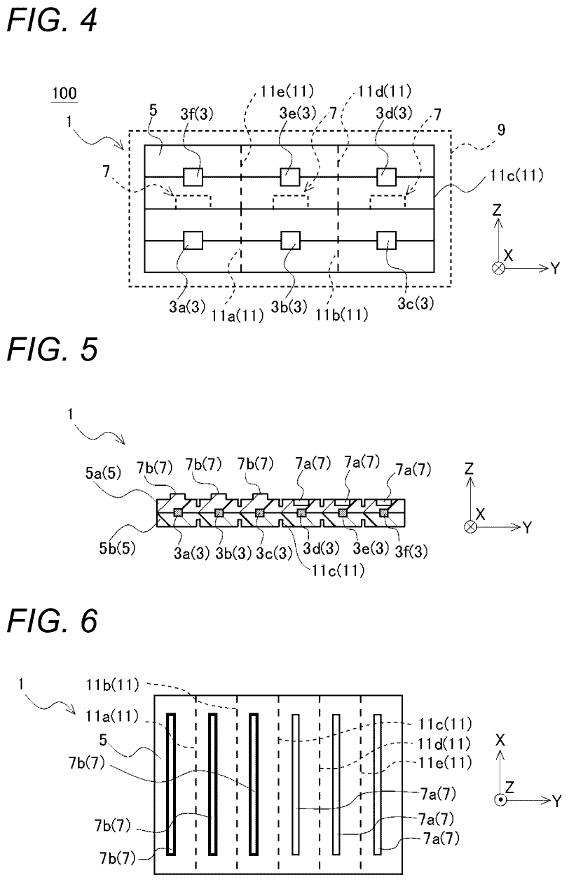

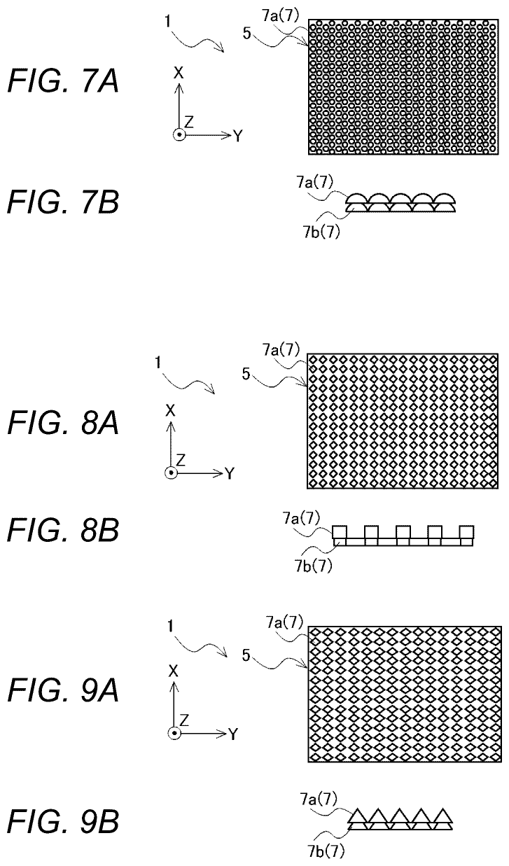

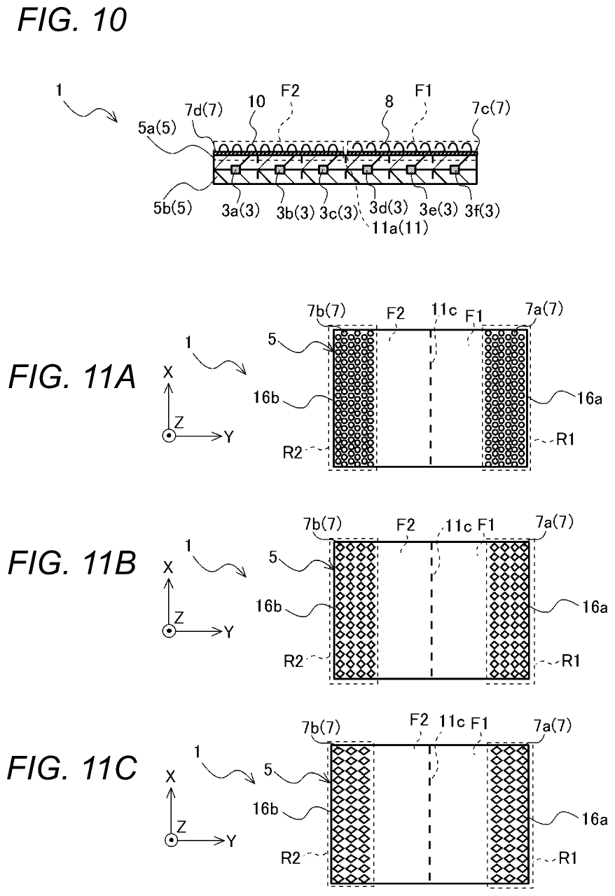

First, a configuration of a flat wiring laminated member according to an embodiment of the present disclosure will be described with reference to FIGS. 1 to 11C. FIG. 1 is a plan view illustrating the flat wiring laminated member according to the embodiment of the present disclosure. FIG. 2 is a cross-sectional view taken along a line A-A in FIG. 1. FIG. 3 is a cross-sectional view illustrating a modification of an electric wire of the flat wiring laminated member illustrated in FIG. 2. FIG. 4 is a front view illustrating a state in which the flat wiring laminated member illustrated in FIG. 1 is folded. FIG. 5 is a cross-sectional view illustrating a modification of a tearing portion of the flat wiring laminated member illustrated in FIG. 2. FIG. 6 is a plan view illustrating a first modification of a concave portion and a convex portion included in the flat wiring laminated member, and corresponds to FIG. 1. FIGS. 7A and 7B are diagrams illustrating a second modification of the concave portion and the convex portion included in the flat wiring laminated member, in which FIG. 7A is a plan view illustrating a state in which the flat wiring laminated member is folded and laminated, and FIG. 7B is a partially enlarged front view of FIG. 7A. FIGS. 8A and 8B are diagrams illustrating a third modification of the concave portion and the convex portion included in the flat wiring laminated member, in which FIG. 8A is a plan view illustrating a state in which the flat wiring laminated member is folded and laminated, and FIG. 8B is a partially enlarged front view of FIG. 8A. FIGS. 9A and 9B are diagrams illustrating a fourth modification of the concave portion and the convex portion included in the flat wiring laminated member, in which FIG. 9A is a plan view illustrating a state in which the flat wiring laminated member is folded and laminated, and FIG. 9B is a partially enlarged front view of FIG. 9A. FIG. 10 is a cross-sectional view illustrating a fifth modification of the concave portion and the convex portion included in the flat wiring laminated member, and corresponds to FIG. 2. FIGS. 11A to 11C are plan views illustrating a sixth modification of the concave portion and the convex portion included in the flat wiring laminated member, in which FIG. 11A illustrates a case in which a planar shape of the concave portion and the convex portion is circular, FIG. 11B illustrates a case in which the planar shape of the concave portion and the convex portion is square, and FIG. 11C illustrates a case in which the planar shape of the concave portion and the convex portion is rhombic.

A flat wiring laminated member 1 illustrated in FIG. 1 is a member for manufacturing a wire harness 100 described later used in an automobile or the like, and includes electric wires 3, a sheet member 5, tearing portions 11, and a fixing portion 7 as illustrated in FIG. 2. The electric wire 3 is a member serving as wiring in the flat wiring laminated member 1, has a linear outer shape, extends in an X direction, which is an axial direction of the electric wire, and is arranged in a width direction orthogonal to the X direction, here, a Y direction. The electric wire 3 is not particularly limited as long as it satisfies conductivity, strength, and the like required for wiring. For example, conductors such as flat wires 3a to 3f (electric wires) can be exemplified as illustrated in FIG. 2, but various strand wires, solid wires, or insulated electric wires 4a to 4f (electric wires) in which strand wires are covered with an insulating sheath such as polyvinyl chloride (PVC) or polyolefin as illustrated in FIG. 3, may also be used. The electric wire 3 may be a twisted wire or a coaxial wire. The electric wire 3 may be an optical fiber instead of a conductor.

The sheet member 5 is a sheet-like insulator that collectively covers the electric wires 3, and includes an upper layer 5a and a lower layer 5b. The upper layer 5a is a sheet-like insulating member covering the electric wires 3 from above, and the lower layer 5b is a sheet-like insulating member provided below the electric wires 3. As illustrated in FIG. 2, the sheet member 5 collectively covers the electric wires 3 by sandwiching the electric wires 3 between the upper layer 5a and the lower layer 5b and bonding the upper layer 5a and the lower layer 5b together, and fusing the upper layer 5a and the lower layer 5b to the electric wires 3 with heat, ultrasonic waves, or the like. An adhesive such as a hot melt adhesive may be used instead of heat or ultrasonic waves as a section for fusing. The material constituting the upper layer 5a and the lower layer 5b of the sheet member 5 is not particularly limited as long as the material can insulate the electric wire 3 and has a desired strength. Specific examples of the material include laminate coating materials such as polyethylene terephthalate (PET), polyolefin, fluororesin, PVC, polyimide, silicone, cellophane, and polyamide.

The tearing portion 11 is a portion serving as a fold when the sheet member 5 is folded as illustrated in FIG. 4, and is a portion for branching the end portion of the sheet member 5 by tearing the sheet member 5 in a folded state. The tearing portion 11 is a linear portion provided between the adjacent electric wires 3 in the sheet member 5 as illustrated in FIG. 2 and formed along the electric wire 3 (see FIG. 2) in a manner of connecting one end portion 6a and the other end portion 6b in the X direction, which is the axial direction, as illustrated in FIG. 1. In FIG. 1, tearing portions 11a to 11e extending in the X direction are illustrated as the tearing portion 11. Among the tearing portions 11, for example, the tearing portion 11a is provided between the flat wire 3a and the flat wire 3b, which are adjacent electric wires 3, as illustrated in FIG. 2.

The tearing portion 11 has a structure allowed to be torn along the linear portion with a tearing force (load) of less than 4.91 N. In this configuration, by applying a tearing force of less than 4.91 N to the tearing portion 11, the sheet member 5 is torn at the tearing portion 11, and the wiring branches. By adopting such a structure for the tearing portion 11, the tearing portion 11 can be torn and a part of the wiring can be branched without providing a structure for easily tearing the tearing portion 11 such as a cut portion in the sheet member 5. Therefore, even in a structure in which a flat member can be folded and laminated, the wiring can be branched at a desired position without previously providing a cut portion according to a length for branching the wiring. A lower limit of the tearing force is not particularly limited, but is, for example, 1.5 N or more.

A specific structure of the tearing portion 11 is not particularly limited as long as the tearing portion 11 is a portion corresponding to a fold when the sheet member 5 is folded, that is, a rotation axis of a hinge, and allows the sheet member 5 in the folded state to be torn. In FIG. 1, a perforation is illustrated as the tearing portion 11. In a case in which the tearing portion 11 is a perforation, as a section for forming a structure allowed to be torn along a line with a tearing force of less than 4.91 N, for example, a length of a joint and a length of a cut in the perforation may be adjusted. The perforation may be formed, for example, using a tool such as a perforation cutter after the electric wire 3 is covered with the sheet member 5, or may be formed by an extruder when the sheet member 5 is formed by extrusion molding.

As illustrated in FIG. 5, the tearing portion 11 may be a thin portion. When the tearing portion 11 is a thin portion, for example, the thickness of the thin portion may be adjusted as a section for forming a structure allowed to be torn along the linear portion with a tearing force of less than 4.91 N. Specifically, the thin portion may be formed by an extruder when the sheet member 5 is formed by extrusion molding, for example.

Whether the tearing portion 11 is a perforation or a thin portion may be appropriately selected in consideration of respective advantages. For example, in a case in which the tearing portion is a perforation, it is possible to form the perforation with a perforation cutter or form the perforation by extrusion molding, which is advantageous in that there is a wide range of options for the manufacturing method. Meanwhile, in a case in which the tearing portion 11 is a thin portion, no cut is formed in the tearing portion 11, which is advantageous in that the strength of the sheet member 5 can be easily increased.

The fixing portion 7 is a member that fixes the sheet member 5 in a state in which overlapping surfaces are folded, and is provided on the overlapping surfaces of the sheet member 5 in a folded state. For example, a case illustrated in FIG. 2 is considered in which the tearing portion 11c is used as a fold, and a surface F1 (one of the overlapping surfaces) on the right side of the tearing portion 11c is folded back and overlapped with a surface F2 (the other of the overlapping surfaces) on the left side, as indicated by an arrow B. In this case, the fixing portion 7 includes concave portions 7a and convex portions 7b. The concave portion 7a is a dot-shaped recess formed on the right surface F1 of the sheet member 5, which is one of the overlapping surfaces in the folded state. The convex portion 7b is formed on the left surface F2, which is the other of the overlapping surfaces in the folded state, and is a dot-shaped protruding portion to be fitted into the concave portion 7a. In this configuration, the surface F1 on the right side of the tearing portion 11c is folded back and folded on the surface F2 on the left side with the tearing portion 11c as a fold, and the convex portion 7b is fitted into the concave portion 7a, so that the surface F2 on the left side and the surface F1 on the right side are fixed in the folded state. In this configuration, since the positions of the overlapping surfaces at the time of fixing are determined by the positions of the concave portion 7a and the convex portion 7b, it is easy to improve the accuracy of positioning of the overlapping surfaces.

The concave portion 7a and the convex portion 7b may be integrated with the sheet member 5 as illustrated in FIG. 2, but may be separate members from the sheet member 5. In a case in which the concave portion 7a and the convex portion 7b are integrated with the sheet member 5, the concave portion 7a and the convex portion 7b may be formed by an extruder when the sheet member 5 is formed by extrusion molding. Additionally, the concave portion 7a and convex portion 7b may be formed by transferring an uneven shape onto the surfaces of the upper layer 5a and lower layer 5b of the sheet member 5, which can be achieved by providing the uneven shape on the surface of a pressing section such as a roller used when bonding the upper layer 5a and lower layer 5b. In a case in which the concave portion 7a and the convex portion 7b are separate members from the sheet member 5, the concave portion 7a and the convex portion 7b can be formed by attaching a member, such as an embossed sheet, having an uneven surface to the right surface F1 and the left surface F2 of the sheet member 5.

Although FIG. 1 illustrates a case in which the concave portion 7a and the convex portion 7b have a dot-shaped planar shape, the planar shape of the concave portion 7a and the convex portion 7b is not limited to a dot-shape as long as the overlapping surfaces can be fixed in a state in which the sheet member 5 is folded. For example, as illustrated in FIG. 6, the concave portion 7a and the convex portion 7b may have a linear shape extending in the X direction, which is the axial direction, in plan view. In this configuration, by fitting the linear convex portion 7b into the linear concave portion 7a, the overlapping surfaces in a folded state are fixed. When the concave portion 7a and the convex portion 7b are linear, the concave portion 7a and the convex portion 7b may be formed by extrusion molding or transfer by pressurization.

Whether the concave portion 7a and the convex portion 7b are dotted or linear may be appropriately selected in consideration of respective advantages. For example, in a case in which the concave portions 7a and the convex portions 7b are dotted, the number of the concave portions 7a and the convex portions 7b can be increased as compared with a case in which the concave portions 7a and the convex portions 7b are linear, which is advantageous in that the positioning accuracy is easily improved. Meanwhile, in a case in which the concave portions 7a and the convex portions 7b are linear, the number of the concave portions 7a and the convex portions 7b can be reduced as compared with the case in which the concave portions 7a and the convex portions 7b are dotted, which is advantageous in that the concave portions 7a and the convex portions 7b can be easily formed.

When the concave portion 7a and the convex portion 7b are dotted, the specific planar shape is not particularly limited as long as the overlapping surfaces can be fixed to each other in a state in which the sheet member 5 is folded. For example, the concave portion 7a and the convex portion 7b may have a circular planar shape as illustrated in FIG. 7A, a square planar shape as illustrated in FIG. 8A, or a rhombus planar shape as illustrated in FIG. 9A. The specific three-dimensional shape is not particularly limited as long as the overlapping surfaces can be fixed to each other in a folded state. For example, the three-dimensional shape may be hemispherical as illustrated in FIG. 7B, columnar as illustrated in FIG. 8B, cubic here, or conical as illustrated in FIG. 9B. With these configurations, the convex portion 7b having a circular planar shape, a square planar shape, or a rhombus planar shape is fitted into the concave portion 7a having a circular planar shape, a square planar shape, or a rhombus planar shape, thereby fixing the overlapping surfaces to each other in a state in which the sheet member 5 is folded. These configurations are advantageous in that the planar shape and the three-dimensional shape can be selected widely. In the case in which the concave portion 7a and the convex portion 7b are dotted, it is preferable that the planar shape is a square shape or a rhombus shape because a holding force that is a force for holding a state in which the overlapping surfaces are fixed can be increased. The reason is that a shape having corner portions such as a square or a rhombus has a larger holding force due to engagement between the corner portions of the concave portion 7a and the convex portion 7b when the fixing portion 7 fixes the overlapping surfaces in a state in which the sheet member 5 is folded. The larger the planar dimensions of the concave portion 7a and the convex portion 7b, the larger the holding force.

The fixing portion 7 is not limited to the configuration including the concave portion 7a and the convex portion 7b as long as the overlapping surfaces can be fixed in a state in which the sheet member 5 is folded. For example, the fixing portion 7 may be a hook-and-loop fastener as illustrated in FIG. 10. When the fixing portion 7 is a hook-and-loop fastener, the fixing portion 7 includes a hook sheet 7c and a loop sheet 7d. The hook sheet 7c is a sheet-like member having hook portions 8 (fibers), which are hook-shaped fibers, on its surface, and is attached to the right surface F1, which is one of the overlapping surfaces of the sheet member 5 in a folded state. The loop sheet 7d is a sheet-like member having loop portions 10 (fibers), which are loop-shaped fibers to be engaged with the hook portions 8, on its surface, and is attached to the left surface F2, which is the other of the overlapping surfaces of the sheet member 5 in a folded state. With this configuration, by bonding the hook sheet 7c and the loop sheet 7d, the hook portion 8 is engaged with the loop portion 10, and the left surface F2 and the right surface F1 are fixed to each other. With this configuration, the fixing portion 7 can be formed only by attaching an existing hook-and-loop fastener to the surface of the sheet member 5 (upper layer 5a).

The fixing portion 7 is not necessarily provided on the entire overlapping surfaces of the sheet member 5 in the folded state, and may be provided in a partial region of the overlapping surfaces in the folded state. For example, as illustrated in FIGS. 11A to 11C, a case is considered in which the tearing portion 11c is used as a fold, and the surface F1 on the right side of the tearing portion 11c is folded back and overlapped with the surface F2 on the left side. In this case, the concave portion 7a is provided in a partial region R1 along an end portion 16a in the Y direction which is the width direction of the right surface F1, and the convex portion 7b is provided in a partial region R2 along an end portion 16b in the Y direction which is the width direction of the left surface F2. With this configuration, the end portion 16a and the end portion 16b in the width direction of the overlapping surfaces in the folded state are fixed. Therefore, the overlapping surfaces of the sheet member 5 can be fixed to each other without providing the fixing portion 7 on the entire overlapping surfaces.

The flat wiring laminated member 1 may have flexibility like a flexible flat cable, but may have the same structure as a flat cable having no flexibility as long as the flat wiring laminated member 1 can be folded with the tearing portion 11 as a fold. The configuration of the flat wiring laminated member 1 is described above.

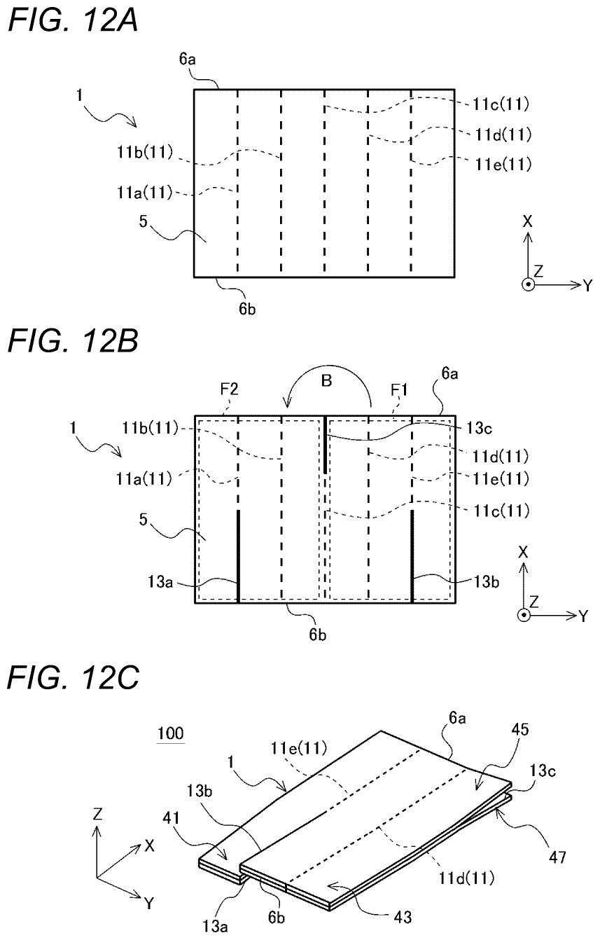

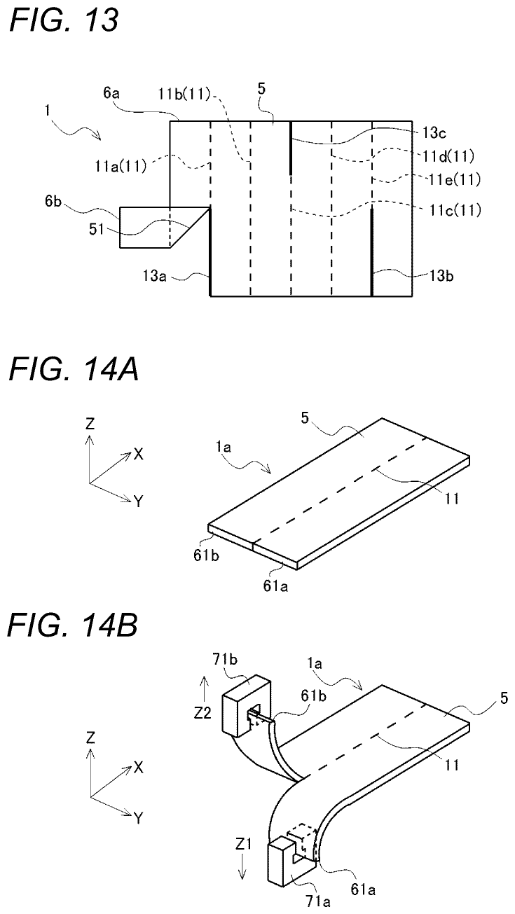

Next, a procedure for manufacturing a wire harness using the flat wiring laminated member 1 will be described with reference to FIGS. 12A to 12C and 13. FIGS. 12A to 12C are diagrams illustrating a procedure for manufacturing the wire harness, in which FIG. 12A illustrates the flat wiring laminated member 1 (a fixing portion is omitted) used for manufacturing, FIG. 12B illustrates a state in which a part of the tearing portions 11a to 11e illustrated in FIG. 12A is torn, and FIG. 12C illustrates a state in which the sheet member 5 illustrated in FIG. 12B is folded. FIG. 13 is a plan view illustrating a modification of folding the sheet member 5 illustrated in FIG. 12.

First, as illustrated in FIG. 12A, the flat wiring laminated member 1 is prepared, and a part of end portions 6a and 6b of the sheet member 5 is cut in the Y direction as necessary to expose the electric wire 3, and a terminal (not illustrated) and the exposed electric wire 3 are electrically connected. Next, as illustrated in FIG. 12B, a tearing force of less than 4.91 N is applied to a portion to be branched among the tearing portions 11a to 11e, and the portion is torn halfway. In FIG. 12B, the tearing portion 11c is torn halfway from the end portion 6a toward the end portion 6b to form a cleavage portion 13c. In addition, the tearing portions 11a and 11e are torn halfway from the end portion 6b toward the end portion 6a to form cleavage portions 13a and 13b. Further, the flat wiring laminated member 1 is folded and laminated. Specifically, as indicated by an arrow B in FIG. 12B, the surface F1 on the right side is folded back with the tearing portion 11c as a fold and laminated on the surface F2 on the left side, and is fixed by the fixing portion 7 (not illustrated), whereby the wire harness 100 is completed as illustrated in FIG. 12C. In the wire harness 100 illustrated in FIG. 12C, the end portion 6b is branched into a branch portion 41 and a branch portion 43 by the cleavage portions 13a and 13b in the middle in the Y direction. In the wire harness 100, the end portion 6a branches into the branch portion 45 and the branch portion 47 by the cleavage portion 13c in the middle in the X direction. In this way, in the wire harness 100, the sheet member 5 is torn at the tearing portion 11 by applying a tearing force of less than 4.91 N to the tearing portion 11, and the wiring branches. By adopting such a structure for the tearing portion 11, the tearing portion 11 can be torn and a part of the wiring can be branched without providing a structure for easily tearing the tearing portion 11 such as a cut portion in the sheet member 5. Therefore, even in a structure in which a flat member can be folded and laminated, the wiring can be branched at a desired position without previously providing a cut portion according to a length for branching the wiring.

In FIGS. 12A to 12C, since the flat wiring laminated member 1 is folded with the tearing portion 11 formed parallel to the X direction which is the axial direction of the electric wire 3 as a fold, the fold is a straight line parallel to the X direction, but the fold is not limited to a straight line parallel to the X direction and may be a curved line. Alternatively, like a fold 51 illustrated in FIG. 13, the fold may be such that the direction of the end portion 6b is perpendicular to the end portion 6a. Therefore, the folded portion such as the fold 51 may not necessarily be the tearing portion 11.

In addition, in FIGS. 12A to 12C, the right side surface F1 and the left side surface F2 to be folded on each other have the same dimension and shape, but the right side surface F1 and the left side surface F2 do not need to have the same dimension and shape, and there may be a difference in length, presence or absence of a cut, presence or absence of a hole, or the like. Further, the layers to be folded do not need to have the same shape as long as the layers can be spread on a plane and can be folded. Further, in the wire harness 100, when it is desired to more firmly fix the right surface F1 and the left surface F2, as illustrated in FIG. 4, a tape 9 such as an adhesive tape or a hook-and-loop fastener may be wound around the outer periphery when viewed from the X direction. The procedure for manufacturing the wire harness 100 using the flat wiring laminated member 1 is described above.

As described above, the flat wiring laminated member 1 according to the present embodiment includes the electric wire 3, the sheet member 5 covering the electric wire 3 and allowed to be folded, the tearing portion 11 that serves as a fold of the sheet member 5 and allowed to be torn at less than 4.91 N, and the fixing portion 7 configured to fix the overlapping surfaces of the sheet member 5. In this configuration, by applying a tearing force of less than 4.91 N to the tearing portion 11, the sheet member 5 is torn at the tearing portion 11, and the wiring branches. By adopting such a structure for the tearing portion 11, the tearing portion 11 can be torn and a part of the wiring can be branched without providing a structure for easily tearing the tearing portion 11 such as a cut portion in the sheet member 5. Therefore, even in a structure in which a flat member can be folded and laminated, the wiring can be branched at a desired position without previously providing a cut portion according to a length for branching the wiring.

In the flat wiring laminated member 1 according to the present embodiment, the tearing portion 11 may be a perforation. With this configuration, the sheet member 5 is folded and torn along the perforation. In this configuration, it is possible to form the perforation with a perforation cutter or form the perforation by extrusion molding, which is advantageous in that there is a wide range of options for the manufacturing method.

Further, in the flat wiring laminated member 1 according to the present embodiment, the tearing portion 11 may be a thin portion. With this configuration, the sheet member 5 is folded and torn along the thin portion. This configuration is advantageous in that the strength of the sheet member 5 can be easily increased because no cut is formed in the tearing portion 11.

Meanwhile, in the flat wiring laminated member 1 according to the present embodiment, the fixing portion 7 includes the concave portion 7a formed on the right surface F1, which is one of the overlapping surfaces of the sheet member 5 in the folded state, and the convex portion 7b formed on the left surface F2, which is the other of the overlapping surfaces of the sheet member 5 in the folded state, and configured to be fitted into the concave portion 7a. In this configuration, by fitting the convex portion 7b into the concave portion 7a, the overlapping surfaces in the folded state are fixed. In this configuration, since the positions of the overlapping surfaces at the time of fixing are determined by the positions of the concave portion 7a and the convex portion 7b, it is easy to improve the accuracy of positioning of the overlapping surfaces.

In the flat wiring laminated member 1 according to the present embodiment, the concave portion 7a and the convex portion 7b may each have a linear shape extending in the X direction, which is the axial direction, in plan view. In this configuration, by fitting the linear convex portion 7b into the linear concave portion 7a, the overlapping surfaces in the folded state are fixed. In this configuration, since the number of the concave portions 7a and the convex portions 7b can be reduced as compared with the case in which the concave portions 7a and the convex portions 7b are dotted, the concave portions 7a and the convex portions 7b can be easily formed.

Further, in the flat wiring laminated member 1 according to the present embodiment, the concave portion 7a and the convex portion 7b may have any one of a circular shape, a square shape, or a rhombus shape in plan view. In this configuration, by fitting the circular, square, or rhombic convex portion 7b into the circular, square, or rhombic concave portion 7a, the overlapping surfaces in the folded state are fixed. These configurations are advantageous in that the planar shape and the three-dimensional shape can be selected widely.

Meanwhile, in the flat wiring laminated member 1 according to the present embodiment, the fixing portion 7 may be a hook-and-loop fastener including the hook sheet 7c formed on the right surface F1 of the sheet member 5 and formed with the hook portion 8, and the loop sheet 7d formed on the left surface F2 and formed with the loop portion 10. With this configuration, the hook portion 8 is engaged with the loop portion 10 by bonding the hook sheet 7c and the loop sheet 7d of the hook-and-loop fastener, and the overlapping surfaces in the folded state are fixed. Therefore, the fixing portion 7 can be formed only by attaching an existing hook-and-loop fastener to the upper layer 5a of the sheet member 5.

In the flat wiring laminated member 1 according to the present embodiment, the fixing portion 7 is provided in the partial regions R1 and R2 along the end portions 16a and 16b in the width direction of the overlapping surfaces of the sheet member 5 in the folded state. With this configuration, the end portions 16a and 16b in the width direction of the overlapping surfaces in the folded state are fixed to each other. Therefore, the overlapping surfaces can be fixed to each other without providing the fixing portion 7 on the entire overlapping surfaces.

The wire harness 100 according to the present embodiment is obtained by folding and laminating the flat wiring laminated member 1, and includes the flat wiring laminated member 1. Therefore, even in a structure in which a flat member can be folded and laminated, the distal end can be branched without previously providing a cut portion. In addition, since the wire harness 100 according to the present embodiment is formed by folding and laminating one flat wiring laminated member 1, the width of the wire harness 100 can be narrowed to any width by adjusting the number of times of folding. Further, the present disclosure can be applied to a position where the number of circuits and the number of branches are large. Further, since the wire harness 100 according to the present embodiment is formed by folding and laminating one flat wiring laminated member 1, it is not necessary to manufacture and laminate a plurality of flat wiring laminated members 1. In addition, since the wire harness 100 according to the present embodiment forms a conductive path by folding and laminating the sheet-like flat wiring laminated member 1, the wire harness 100 is excellent in workability such as terminal striking for connecting a terminal to the electric wire 3 or peeling off a part of the sheet member 5 when connecting a terminal. Further, in the wire harness 100 according to the present embodiment, since the deviation during laminating is reduced by the fixing portion 7, the length and work tolerances can be narrowed.

Hereinafter, the present disclosure will be specifically described based on examples, but the present disclosure is not limited to the examples.

### (Folding and Tearing Test)

First, as a test for confirming whether folding and tearing were possible, a flat cable illustrated in FIG. 14 was produced, and whether folding and tearing were possible was tested. FIGS. 14A and 14B are perspective views illustrating the flat cable used in the test for confirming whether folding and tearing are possible, in which FIG. 14A illustrates a state before a tearing test is performed, and FIG. 14B illustrates a state during the tearing test, and electric wires 3 are not illustrated. First, a flat cable 1a as illustrated in FIGS. 14A and 14B was produced. Specifically, first, a 14-core cable having a dimension of 0.13 sq extending in the X direction and arranged in the Y direction was prepared as the electric wire 3 (not illustrated). Next, as the sheet member 5, two PET films each having a total thickness of 0.3 mm and an adhesive layer of 0.042 mm formed on the surface were prepared, and the adhesive layers were bonded to each other with the electric wire 3 interposed between the two PET films to produce the flat cable 1a. The number of produced flat cables 1a was seven, and these are referred to as Sample Nos. 1 to 7. Next, perforations serving as the tearing portions 11 were formed so as to be parallel to the X direction between the two electric wires 3 of the produced seven flat cables 1a using a commercially available perforation cutter. Specifically, for the seven flat cables 1a, the perforations were formed such that the length of the cut of the perforations had different values in a range of 1 mm to 4 mm and the length of the joint of the perforations had different values in a range of 1 mm to 5 mm.

Next, a tensile and compression testing machine “Strograph VE10D” manufactured by Toyo Seiki-Seisaku-sho, Ltd. was prepared. Further, of the end portions of the flat cable 1a in the X direction, a right end portion 61a which is a portion on the right side of the tearing portion 11 was gripped by a vise chuck 71a illustrated in FIG. 14B which is a jig of the testing machine. Further, the vise chuck 71a was fixed to the tensile and compression testing machine in a posture in which the right end portion 61a faces a direction Z1 which is downward in the Z direction. In addition, of the end portions of the flat cable 1a in the X direction, a left end portion 61b which is a portion on the left side of the tearing portion 11 was gripped by a vise chuck 71b which is another jig of the testing machine, and the vise chuck 71b was fixed to the tensile and compression testing machine. Further, the tensile and compression testing machine was driven to raise the vise chuck 71b at a speed of 50 mm/min in a direction Z2 which is upward in the Z direction in a state in which the vise chuck 71a was fixed to pull the left end portion 61b, thereby tearing the tearing portion 11 by 125 mm. Other test conditions were as described in JIS K 6854 (1999). After tearing, whether a portion other than the tearing portion 11 in the sheet member 5 was broken was visually evaluated, and a case in which the portion was not broken was determined as “Tearing: A”. Meanwhile, a case in which the portion other than the tearing portion 11 was broken, specifically, a case in which when the tearing was performed, the portion other than the tearing portion 11 was also torn, and the sheet member 5 could not be torn along the linear portion of the tearing portion 11, it was determined as “Tearing: B”. Thereafter, the flat cable 1a was removed from the tensile and compression testing machine, and it was manually confirmed whether the flat cable 1a could be folded with the tearing portion 11 as a fold. As a result, a case in which the flat cable 1a could be folded without breaking the sheet member 5 was determined as “Folding: A”, and a case in which the flat cable 1a could not be folded without breaking the sheet member 5 was determined as “Folding: B”. The results are illustrated in Table 1.

TABLE 1

| | | | Tearing | | |
|---|---|---|---|---|---|
| Sample No. | Cut (mm) | Joint (mm) | force (N) | Folding | Tearing |
| 1 | 3 | 1 | 3.42 | A | A |
| 2 | 1 | 3 | 3.63 | A | A |
| 3 | 2 | 2 | 4.11 | A | A |
| 4 | 3 | 2 | 4.27 | A | A |
| 5 | 3 | 3 | 4.37 | A | A |
| 6 | 4 | 4 | 4.91 | A | B |
| 7 | 4 | 5 | 4.95 | B | B |

As illustrated in Table 1, Sample Nos. 1 to 5 were flat cables 1a in which the tearing portion 11 was torn with a tearing force of less than 4.91 N, and both the tearing and folding were “A”. Meanwhile, Sample No. 6 was the flat cable 1a in which the tearing portion 11 was torn with a tearing force of 4.91 N, and the folding was “A”, but the tearing was “B”. Sample No. 7 was the flat cable 1a in which the tearing portion 11 was torn with a tearing force of 4.95 N, and both the tearing and folding were “B”. From these results, it was found that when the tearing force is less than 4.91 N, the tearing portion 11 can be torn and folded regardless of the ratio of the length of the cut and the length of the joint.

### (Lamination Test)

Next, an attempt was made to manufacture the wire harness 100 by forming the fixing portion 7 on the surface of the flat cable 1a that could be folded and torn in the tearing and folding test, then folding and laminating the flat cable 1a, and fixing the folded state by the fixing portion 7. The fixing portion 7 was made of two types of material: an embossed sheet (having a circular planar shape, a square planar shape, or a rhombus planar shape, in which irregularities having a length of 5.5 mm, a width of 3.0 mm, and a depth of 1.0 mm are arranged without a gap) and a hook-and-loop fastener (hook-and-loop fastener PST-019) manufactured by Pstyle). The planar dimensions of the fixing portion were 6 cm in width and 1 cm in length.

As a result, whether the fixing portion 7 is an embossed sheet or a hook-and-loop fastener, the state in which the sheet member 5 is folded and overlapped can be held by the fixing portion 7, and the wire harness 100 can be manufactured. In addition, the positional deviation between the folded and laminated surfaces of the wire harness 100 was 0.5 mm or less in the front, rear, left, and right directions, and the layers could be laminated with high accuracy.

Although the present disclosure has been described above based on the embodiment, the present disclosure is not limited to the above embodiment, and modifications may be made without departing from the gist of the present disclosure and other techniques may be appropriately combined if possible. Further, public or well-known techniques may be combined if possible.

For example, in the above embodiment, a case in which the flat wiring laminated member 1 is folded once and laminated in two layers is exemplified, but the number of laminated layers may be three or more. In this case, the flat wiring laminated member 1 may be folded in a bellows shape, for example.

In the above embodiment, in the fixing portion 7, only the concave portion 7a is formed on the right surface F1, which is one of the overlapping surfaces of the sheet member 5 in the folded state, and only the convex portion 7b is formed on the left surface F2, which is the other of the overlapping surfaces of the sheet member 5 in the folded state, but the arrangement of the concave portion 7a and the convex portion 7b is not limited to this arrangement. Specifically, in the fixing portion 7, the concave portion 7a may be formed on one surface and the convex portion 7b to be fitted into the concave portion 7a may be formed on the other surface in the folded state. More specifically, the concave portion 7a and the convex portion 7b may be provided on one surface, and the convex portion 7b and the concave portion 7a to be fitted into the concave portion 7a and the convex portion 7b on the one surface may be provided on the other surface.

What is claimed is:

1. A flat wiring laminated member comprising:
a plurality of electric wires each having a linear outer shape and arranged in a width direction orthogonal to an axial direction of the electric wire; and
a sheet member that is a sheet-like insulator collectively covering the plurality of electric wires and is allowed to be folded and laminated in a state of covering the electric wires; wherein
the sheet member includes
a linear tearing portion that is formed in a manner of connecting one end portion and another end portion in the axial direction between the electric wires adjacent to each other in the sheet member, and serves as a fold when the sheet member is folded, the linear tearing portion being allowed to be torn along the linear portion with a tearing force of less than 4.91 N, and
a fixing portion that is provided on overlapping surfaces of the sheet member in a folded state and configured to fix the overlapping surfaces in the folded state.

2. The flat wiring laminated member according to claim 1, wherein
the tearing portion is a perforation.

3. The flat wiring laminated member according to claim 1, wherein
the tearing portion is a thin portion.

4. The flat wiring laminated member according to claim 1, wherein
the fixing portion includes a concave portion formed on one of the overlapping surfaces of the sheet member and a convex portion formed on the other of the overlapping surfaces and configured to be fitted into the concave portion.

5. The flat wiring laminated member according to claim 4, wherein
the concave portion and the convex portion each have a linear shape extending in the axial direction in plan view.

6. The flat wiring laminated member according to claim 4, wherein
the concave portion and the convex portion each have any one of a circular shape, a square shape, or a rhombus planar shape in plan view.

7. The flat wiring laminated member according to claim 1, wherein
the fixing portion is a hook-and-loop fastener including a hook sheet formed on one of the overlapping surfaces of the sheet member and having hook-shaped fibers, and a loop sheet formed on the other of the overlapping surfaces and having loop-shaped fibers configured to engage with the hook-shaped fibers.

8. The flat wiring laminated member according to claim 1, wherein
the fixing portion is provided in a partial region along an end portion in the width direction of each of the overlapping surfaces of the sheet member.

9. A wire harness, wherein
the sheet member of the flat wiring laminated member according to claim 1 is folded and laminated.
